(19) United States
(12) Patent Application Publication
(10) Pub. No.: US 2026/0006333 A1
(43) Pub. Date: Jan. 1, 2026

(54) CONTROL APPARATUS, CONTROL METHOD, AND NON-TRANSITORY COMPUTER-READABLE STORAGE MEDIUM

(71) Applicant: CANON KABUSHIKI KAISHA, Tokyo (JP)

(72) Inventor: YOSHITO ANDO, Tochigi (JP)

(21) Appl. No.: 19/232,204

(22) Filed: Jun. 9, 2025

(30) Foreign Application Priority Data
Jun. 26, 2024 (JP) 2024-103281

(51) Int. Cl. H04N 23/69; H04N 23/61

(52) U.S. Cl. CPC H04N 23/69; H04N 23/61

(57) ABSTRACT

A control apparatus determines a template applicable to control of an angle of view of an imaging apparatus from a plurality of templates, each including predetermined information related to an arrangement of an object, and controls the angle of view of the imaging apparatus based on the arrangement of the object specified in the determined template.

### BACKGROUND

### Field of the Technology

The present disclosure relates to a control apparatus, a control method, and a non-transitory computer-readable storage medium.

### Description of the Related Art

Techniques for automatically controlling the angle of view of a camera by adjusting pan, tilt, and zoom are known.

For example, Japanese Patent Laid-Open No. 2023-118466 discloses a technique for setting the angle of view based on a template that defines a distribution of images of objects. In Japanese Patent Laid-Open No. 2023-118466, preset information is searched for based on a preset registration number inputted by the operator, and a template included in the preset information is obtained.

However, in the technique of Japanese Patent Laid-Open No. 2023-118466, since an operator has to input a preset registration number, in other words, select preset information that includes a template, the operator's burden is large.

### SUMMARY

Therefore, the present disclosure provides a technique that reduces burden on the operator and allows automatic control of the angle of view.

According to one aspect of the present disclosure, there is provided a control apparatus determines a template applicable to control of an angle of view of an imaging apparatus from a plurality of templates, each including predetermined information related to an arrangement of an object, and controls the angle of view of the imaging apparatus based on the arrangement of the object specified in the determined template.

Features of the present disclosure will become apparent from the following description of embodiments with reference to the attached drawings. The following description of embodiments are described by way of example.

### BRIEF DESCRIPTION OF THE DRAWINGS

The accompanying drawings, which are incorporated in and constitute a part of the specification, illustrate embodiments of the present disclosure, and together with the description, serve to explain the principles of the embodiments.

FIG. 1 is a schematic diagram illustrating an overall configuration of an imaging system according to the present embodiment.

FIG. 2 is a block diagram illustrating an example of a hardware configuration of a camera according to the present embodiment.

FIG. 3 is a block diagram illustrating a configuration of software functions of the camera according to the present embodiment.

FIG. 4 is a diagram illustrating an example of a template information table for controlling the angle of view.

FIG. 5A is a diagram illustrating an example of a respective range included in template information and illustrates an example of a direction range.

FIG. 5B is a diagram illustrating an example of a respective range included in template information and illustrates an example of a position range.

FIG. 5C is a diagram illustrating an example of a respective range included in template information and illustrates an example of a size range.

FIG. 6 is a flowchart diagram of angle-of-view control processing to be executed by the camera according to the present embodiment.

### DESCRIPTION OF THE EMBODIMENTS

Hereinafter, embodiments will be described in detail with reference to the attached drawings. Note, the following embodiments are not intended to limit the scope of the claims. Multiple features are described in the embodiments, but it is not the case that all such features are required, and multiple such features may be combined as appropriate. Furthermore, in the attached drawings, the same reference numerals are given to the same or similar configurations, and redundant description thereof is omitted.

### EMBODIMENT

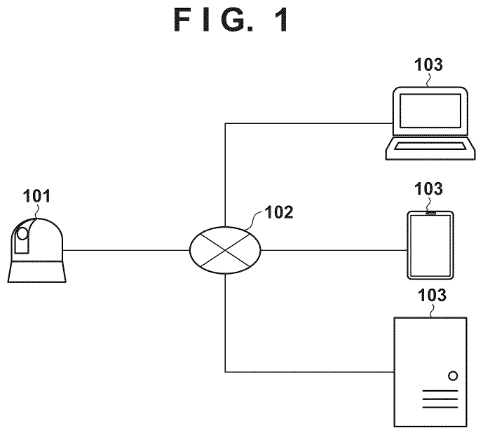

FIG. 1 is a schematic diagram illustrating an overall configuration of an imaging system according to the present embodiment. An example of a configuration of the imaging system according to the present embodiment will be described with reference to FIG. 1.

The imaging system according to the present embodiment includes a camera 101, which is an example of an angle-of-view control apparatus and an imaging apparatus, and an operation input apparatus 103. The camera 101 and the operation input apparatus 103 are connected so to be capable of transmitting and receiving data via a network 102.

The camera 101 receives light from a subject and converts the light into an electrical signal to generate data for an image (also referred to as a captured image). The camera 101 includes an imaging element that converts light, such as a complementary metal-oxide-semiconductor (CMOS) sensor or a charge coupled device (CCD) sensor, into an electric signal to generate an image. The term “image” may include a captured image, a still image, a moving image, a video, and data thereof. The camera 101 includes a pan, tilt, and zoom mechanism and can change the angle of view.

The camera 101 controls the angle of view according to a control signal inputted from the operation input apparatus 103, information detected from a captured image, and the like. The camera 101 can switch between a template imaging mode, an automatic imaging mode, and a manual imaging mode. In the automatic imaging mode, the camera 101 automatically performs pan, tilt, and zoom (PTZ) control based on a captured image or information obtained by a device, such as a sensor, to track and capture an image of a traveling object (hereinafter, a moving object), such as a person, an animal, or a drone. However, the automatic imaging mode may be a state in which the camera 101 or an information processing apparatus connected to the camera 101 controls PTZ without being instructed by an operator. The camera 101 changes operation according to data, such as a control signal received from the operation input apparatus 103 or the like, and is controlled automatically or by the control signal.

The operation input apparatus 103 may be a controller, a personal computer, a smartphone, a tablet terminal, or the like. The operation input apparatus 103 may be a terminal capable of transmitting a control signal to the camera 101 according to a manual operation or the like by an operator. The operation input apparatus 103 receives an operation, such as an input, from an operator and transmits various kinds of data, such as a control signal, to the camera 101.

FIG. 1 is an example illustrating a main configuration, which will be referred to in the following description, in the imaging system of the present embodiment. Thus, the imaging system may include additional apparatuses in addition to the illustrated configuration. For example, the imaging system may include a plurality of cameras connected to the network 102. The imaging system may include a server that distributes images via the network 102; a server that includes, for example, a function of holding images; and the like.

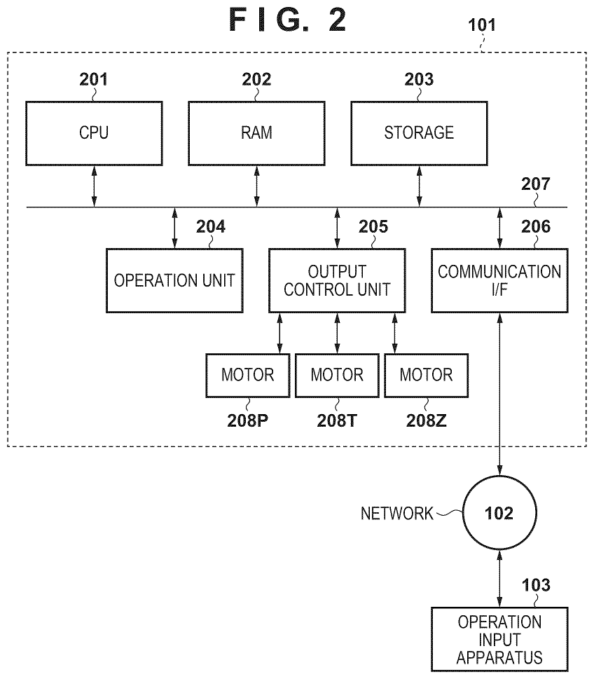

FIG. 2 is a block diagram illustrating an example of a hardware configuration of the camera 101. The hardware configuration of the camera 101 will be described with reference to FIG. 2.

The camera 101 includes a CPU 201, a RAM 202, a storage 203, an operation unit 204, an output control unit 205, a communication I/F 206, and a bus 207. The CPU 201, the RAM 202, the storage 203, the operation unit 204, the output control unit 205, and the communication I/F 206 are connected so as to be capable of transmitting and receiving data to and from each other via the bus 207. In FIG. 2, it is assumed that the camera 101 and the operation input apparatus 103 are connected to a local area network (LAN), but there are various forms of the network 102, which connects the respective apparatuses, and the network 102 is not limited to a particular form.

The CPU 201 is an abbreviation of central processing unit and is a processor that executes various kinds of computational processing. The camera 101 may include one or more other processors, such as a micro processing unit (MPU), a graphics processing unit (GPU), and a quantum processing unit (QPU), in place of or in addition to the CPU 201. The CPU 201 performs various kinds of control of the camera 101. For example, the CPU 201 controls motors 208P, 208T, and 208Z, which are connected to the camera 101 via the output control unit 205 and execute PTZ control. The CPU 201 obtains data via the operation unit 204. Further, the CPU 201 may output generated data to output apparatuses via the output control unit 205. The CPU 201 realizes various kinds of control and functions of the camera 101 by executing computer programs read from the storage 203 and loaded onto the RAM 202. The CPU 201, for example, reads a computer program and executes angle-of-view control processing, which will be described later. The CPU 201 may obtain the above program from another apparatus via the network 102 and the communication I/F 206 and execute the above program. The CPU 201 stores image data in the RAM 202 at execution of a program for image analysis and distribution and reads the image data during execution of the program. The CPU 201 may store an analysis result, such as detection of a person in the image, in the RAM 202.

The RAM 202 is an abbreviation for random access memory. The RAM 202 is a storage medium capable of high-speed reading and writing. The RAM 202 functions as a work area when the CPU 201 executes a program.

The storage 203 stores a boot program to be executed by the CPU 201 at startup of the camera 101, command programs for executing respective processes, data such as image data to be processed by programs, data such as parameters to be used by programs, and the like. The storage 203 may be a readable non-volatile storage medium, such as a read only memory (ROM), or a readable/writable non-volatile storage medium, such as a hard disk drive (HDD) or a solid state drive (SSD).

The operation unit 204 performs processing of a signal and the like received from the operation input apparatus 103 and the like via the communication I/F 206. The operation unit 204 outputs the processed signal to the CPU 201.

The output control unit 205 is connected to output apparatuses, such as motors 208P, 208T, and 208Z for PTZ control. The output control unit 205 outputs a control signal received from the CPU 201 to the motors 208P, 208T, and 208Z. The motor 208P controls pan. The motor 208T controls tilt. The motor 208Z controls zoom. The motors 208P, 208T, and 208Z may each be one or more motors. In the following description, the motors 208P, 208T, and 208Z may be referred to as the motors 208 when they do not need to be distinguished. Further, the camera 101 may include, for PTZ control, an actuator and the like other than motors in place of or in addition to the motors.

The communication I/F 206 receives data from another apparatus, such as the operation input apparatus 103, via the network 102 and transmits the data to the CPU 201. The communication I/F 206 transmits data generated by the CPU 201 to another device via the network 102.

The camera 101 may include hardware, such as one or more integrated circuits (e.g., an application specific integrated circuit (ASIC) and a programmable logic device (PLD), which includes a field programmable gate array (FPGA)), as another configuration.

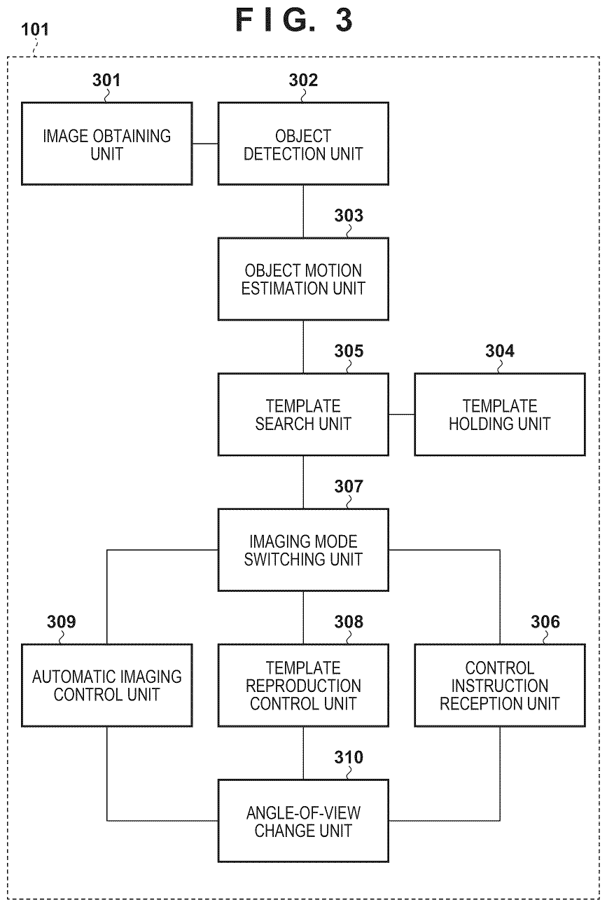

FIG. 3 is a block diagram illustrating a configuration of software functions of the camera 101. The processing at the time of image capturing performed by the camera 101, which includes the functional configuration illustrated in FIG. 3, will be described. Each functional unit illustrated in FIG. 3 will be described as a performer of the processing.

The functions of the camera 101 realized by the respective blocks illustrated in FIG. 3 will be described. The camera 101 includes an image obtaining unit 301, an object detection unit 302, an object motion estimation unit 303, a template holding unit 304, a template search unit 305, a control instruction reception unit 306, an imaging mode switching unit 307, a template reproduction control unit 308, an automatic imaging control unit 309, and an angle-of-view change unit 310.

The CPU 201 may realize the above functional units of the camera 101 by executing a computer program. The CPU 201 may realize some of the functional units of the camera 101 by executing a computer program. The camera 101 may realize some or all of the functional units by the CPU 201 or a processor other than the CPU 201. The camera 101 may realize some or all of the functional units by hardware, such as one or more circuits (e.g., an ASIC and a PLD, which includes FPGA).

The image obtaining unit 301 converts an electric signal obtained from the imaging element into image data and stores the image data in the RAM 202 of the camera 101. The image obtaining unit 301 may obtain the converted image data and store the image data in the RAM 202.

The object detection unit 302 detects an object (also referred to as a subject) in the image obtained by the image obtaining unit 301 by analyzing the image. An example of an object detection method includes a method in which an object in an image is detected and recognized by image recognition in which a neural network is used. The object detection unit 302 detects and outputs at least one of the category of the detected object, the direction of the object in the image, the position of the object in the image, and the size of the object in the image. The category of the object, the direction of the object in the image, the position of the object in the image, and the size of the object in the image are examples of information related to the object. The object detection unit 302 may detect an object in a zoomed-out state, that is, in a state in which many objects are included in the image.

The object motion estimation unit 303 estimates and identifies, by image analysis, the motion of a moving object, which is a traveling object and includes a person, an animal, a drone, or the like, among objects detected by the object detection unit 302. The object motion estimation unit 303 may identify motion through skeleton estimation, captioning, and the like by image recognition in which a neural network is used, but a method of identifying motion is not particularly limited. The object motion estimation unit 303 outputs information identifying an object and the presence or absence and type of motion performed by the object.

The template holding unit 304 holds information (also referred to as template information) of one or more preset templates. The template holding unit 304 may hold a list of a plurality of pieces of template information in a table format. Template information includes, for example, information defining an arrangement of objects as information for reproducing the angle of view (also referred to as composition). Template information includes, for example, at least one of a category (also referred to as type) of an object, and information on a direction, position, size, and the like of the object in the image or information defining a range of information in the image. A template may include information on a plurality of categories of objects. Information included in template information, composition information stored in a template, and the like will be described later in detail.

The template search unit 305 searches for a template applicable to control of the angle of view of the camera 101 from a plurality of templates, each including predetermined information related to an arrangement of an object. For example, the template search unit 305 searches for a template applicable to control of the angle of view of a currently captured image from the template holding unit 304 based on information outputted by the object detection unit 302. A template applicable to control of the angle of view can be said to be a template according to which PTZ control can be executed for an object in the image. The template search unit 305 may search for a template that includes objects whose categories have all been detected in the image by the object detection unit 302 among templates held in the template holding unit 304. When a plurality of templates conform, the template search unit 305 may determine a template to be executed according to template priorities assigned to the templates.

The control instruction reception unit 306 transmits a PTZ parameter, which is a signal for realizing PTZ control of the camera 101, to the angle-of-view change unit 310 according to a control instruction received from the operation input apparatus 103. Further, when a control instruction is received, the imaging mode switching unit 307 is notified of the reception of control instruction.

The imaging mode switching unit 307 switches the imaging mode according to reception statuses of a search result of the template search unit 305, a control instruction notified from the control instruction reception unit 306, and the like. In the present embodiment, the imaging mode switching unit 307 determines in which of the imaging modes (the automatic imaging mode, the template imaging mode, and the manual imaging mode) to capture an image. If the control instruction reception unit 306 has received a control instruction from the operation input apparatus 103, the imaging mode switching unit 307 determines the imaging mode to be the manual control mode for controlling PTZ according to the control signal. If the control instruction reception unit 306 has not received a control instruction and the template search unit 305 has outputted a template applicable to the image, the imaging mode switching unit 307 determines the imaging mode to be the template imaging mode in which the angle of view is controlled by PTZ control that is based on the template. If the control instruction reception unit 306 has not received a control instruction and the template search unit 305 has not found an applicable template, the imaging mode switching unit 307 determines the imaging mode to be the automatic imaging mode in which the angle of view is automatically controlled and an object in the image is automatically tracked.

When the imaging mode switching unit 307 determines the imaging mode to be the template imaging mode, the template reproduction control unit 308 sets a PTZ parameter for adjusting the angle of view so as to achieve composition specified by a template found by the template search unit 305. The template reproduction control unit 308 outputs the PTZ parameter for adjusting the angle of view to the angle-of-view change unit 310. A method of adjusting the angle of view will be described later. A PTZ parameter may also be referred to as PTZ coordinates.

The automatic imaging control unit 309 generates a PTZ parameter for automatically controlling the angle of view based on a result of analysis of a captured image and outputs the parameter to the angle-of-view change unit 310. In other words, the automatic imaging control unit 309 generates a PTZ parameter for realizing PTZ control that allows automatic tracking of an object in the image and capturing of an image of the object based an analysis result and outputs the PTZ parameter to the angle-of-view change unit 310. An analysis result includes the category, direction, position, and size of an object detected by the object detection unit 302 and at least one of the traveling speed and traveling direction of the object estimated by the object motion estimation unit 303. Regarding a method of automatically tracking an object, a method of detecting a movement or a specific part of an object by using a neural network, a method in which template matching is used, and the like may generally be applied. A method of automatic tracking is not particularly limited.

The angle-of-view change unit 310 controls at least one of pan, tilt, and zoom to control and change the angle of view. Specifically, the angle-of-view change unit 310 controls hardware, such as the motors 208, according to a PTZ parameter received from one of the control instruction reception unit 306, the template reproduction control unit 308, and the automatic imaging control unit 309 to execute PTZ control, which changes the angle of view of the camera 101. For example, the angle-of-view change unit 310 may control at least one of pan, tilt, and zoom of the camera 101 based on an arrangement of an object specified in a found template to change and control the angle of view. The angle-of-view change unit 310 may artificially realize PTZ control by using electronic zooming and cutting out a part of the image.

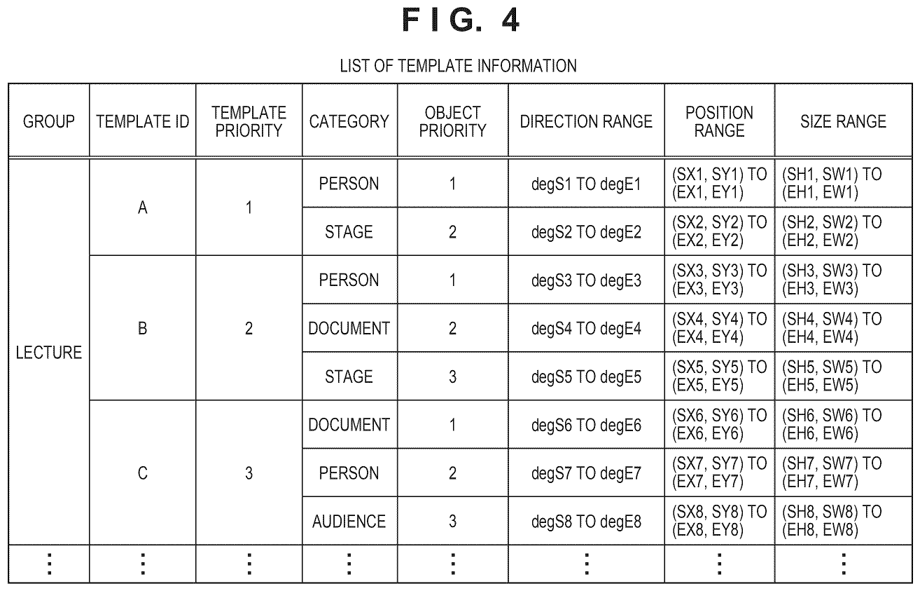

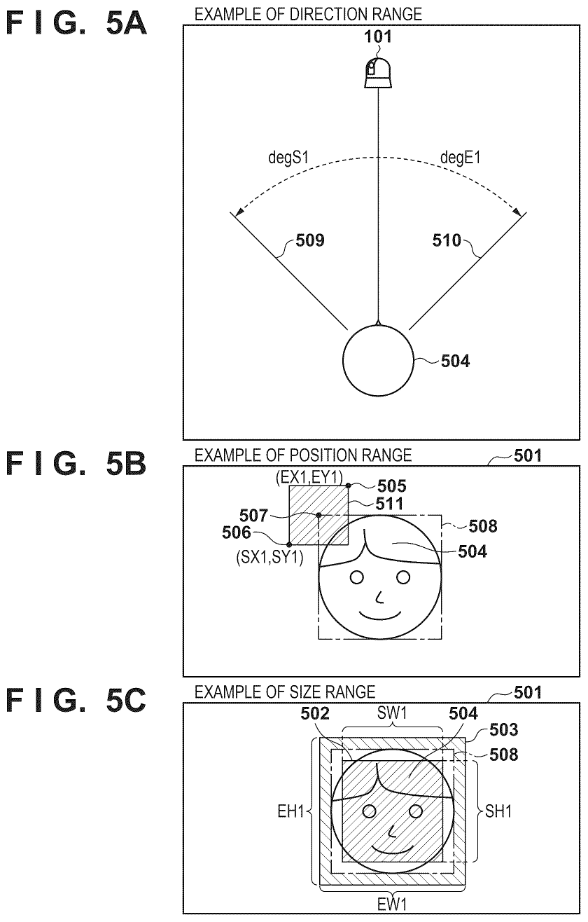

A template information table will be described with reference to FIGS. 4 and 5. A template information table is a list of one or more template information. FIG. 4 is a diagram illustrating an example of a template information table for controlling the angle of view held in the template holding unit 304 of the camera 101. FIG. 5 is a diagram illustrating a direction range, a position range, and a size range included in template information. The template information table is held in the template holding unit 304 of the camera 101.

As illustrated in FIG. 4, the template information table according to the present embodiment includes at least a group, a template ID, a template priority, a category, an object priority, a direction range, a position range, and a size range. Each item of the template information table will be described. The direction range, the position range, and the size range are examples of information related to an arrangement of an object.

A group may be information defining an imaging location, an imaging scene, and the like. A group includes one or more templates. For example, by an operator specifying a group at the time of imaging, the template search unit 305 can limit the search for a template to templates belonging to the specified group, and thus, a more suitable image can be captured.

A template ID is an identifier for identifying a respective template and may be information unique to each template.

A template priority is priority information indicating which template is to be prioritized to control the angle of view when the template search unit 305 determines that a plurality of templates are applicable to control of the angle of view by PTZ control based on the category of an object in the image and the like.

A category indicates the type of an object included in the angle of view. For example, a category may be the name of an object, such as a person or a stage indicated in FIG. 4. Further, a category may be a part of the body of a person, such as the upper body or the face, or a part of an object. The template search unit 305 searches for a template in which the category of an object included in the image matches a category included in the template information.

An object priority is information indicating a priority for determining the position, direction, size, and the like of which object is to be given priority among objects included in the angle of view to adjust the angle of view. Therefore, when there are a plurality of objects of different categories in the image, the template search unit 305 searches for a template according to the object priority.

A direction range represents a range of direction of an object when reproducing the composition defined in a template. A direction range is, for example, information defining, in the case of a person, which direction the face and the front of the body, which is estimated from posture or the like, should be facing with respect to the imaging surface of the camera. FIG. 5A is a diagram illustrating an example of a direction range. Here, an example of a direction range in the upper row of template ID “A” indicated in FIG. 4 will be described. As illustrated in FIG. 5A, the direction in which the face of a person 504 is facing with respect to the imaging surface of the camera 101 is set to 0 degrees. The angle-of-view change unit 310 performs PTZ control such that the direction of the face falls within an angle line 509 indicating degS1 degrees to an angle line 510 indicating degE1 degrees and captures an image.

A position range is represented by two-dimensional coordinates and is information indicating a range that falls within the position coordinates of the object. For example, the position coordinates of an object indicate vertices of a rectangle (bounding box) representing an object region in the image. Generally, the coordinates of the upper left vertex of a rectangle are the position coordinates of an object, but coordinates need only be able to uniquely specify a position among those of all objects in each template. FIG. 5B is a diagram illustrating an example of a position range. An example of a position range in the upper row of template ID “A” indicated in FIG. 4 will be described. As illustrated in FIG. 5B, a rectangle 508 indicates a face region of the person 504 present in a captured angle of view 501. The position range here defines a vertex 506 present at coordinates (SX1, SY1), and a vertex 505 present at coordinates (EX1, EY1). In PTZ control, the angle-of-view change unit 310 performs PTZ control such that the upper left vertex coordinates 507 of the rectangle 508 of the face region falls within a region 511 defined by the vertices 505 and 506 and captures an image.

A size range is information indicating the range of the size of an object region occupied in the image. The angle-of-view change unit 310 executes PTZ control such that the entire rectangle representing an object region has a size that falls within the range specified by the size range. FIG. 5C is a diagram illustrating an example of a size range. An example of a size range in the upper row of template ID “A” indicated in FIG. 4 will be described. As illustrated in FIG. 5C, a region 502 is defined by a height SH1 and a width SW1 of the size range. A region 503 is defined by a height SH1 and a width SW1 of the size range. The angle-of-view change unit 310 executes PTZ control such that the size of the rectangle 508 representing the face region of the person 504 is larger than the region 502 and smaller than the region 503 and captures an image.

The template search unit 305 searches for a template applicable to control of the angle of view by PTZ control from the template information table illustrated in FIG. 4 based on a currently captured image. An applicable template can be said to be a template that can be implemented to control the angle of view of a currently captured image. The template search unit 305 may compare the category, direction, size, and position of an object specified in a template with the category, direction, size, and position of an object captured in a captured image to search for an applicable template.

For example, when one or all categories specified in a template match the category of an object present in the image, the template search unit 305 may determine that the template is applicable to control of the angle of view by PTZ control. Further, when there are different categories of objects in the image, the template search unit 305 may search for a template based on an object with a high object priority.

The template search unit 305 may determine whether a template is applicable by determining whether the direction, position, and size of an object in a currently captured image fall within the direction range, position range, and size range specified by the template. More specifically, the template search unit 305 may determine that a template is applicable when the direction, position, and size of an object in the currently captured image fall within the direction range, position range, and size range specified by the template. However, if by the angle-of-view change unit 310 controlling PTZ of the camera 101 the respective items of the direction, position, and size of an object in the image fall within the ranges specified by a template, the template search unit 305 may determine that the template is applicable.

When there are a plurality of templates determined to be applicable based on comparison of categories and the like, the template search unit 305 may select a template with the highest template priority and output the template as a search result. When a plurality of templates with the same template priority are found, the template search unit 305 may output a template with the smallest difference in composition from a currently captured image as a search result. A difference in composition may be a difference between the direction, position, and size of an object in a currently captured image and composition resulting from PTZ control according to the direction range, position range, and size range specified in the template.

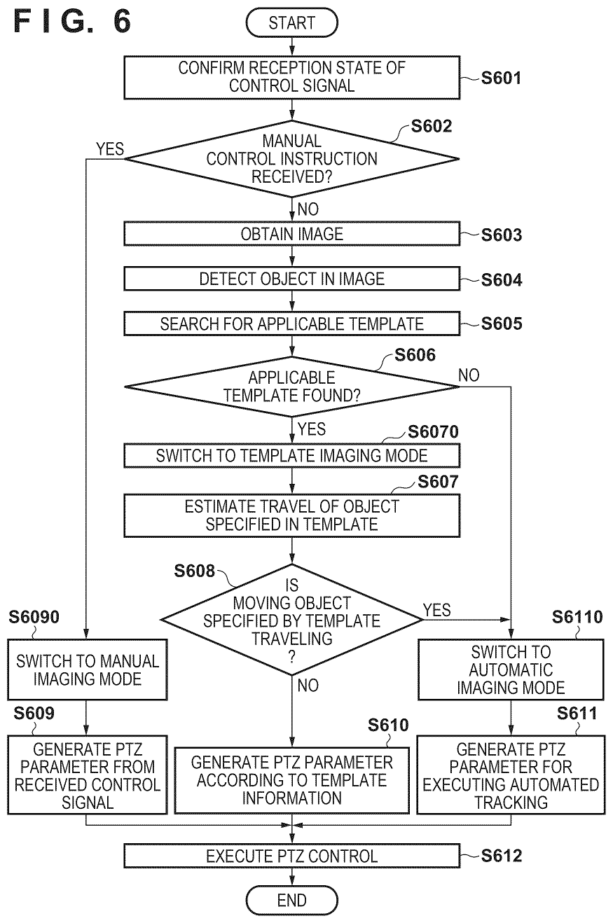

FIG. 6 is a diagram of a flowchart of angle-of-view control processing to be executed by the camera 101. The angle-of-view control processing will be described according to the flowchart of FIG. 6. The CPU 201 executes a computer program for angle-of-view control processing to realize each functional unit illustrated in FIG. 3 and execute each step of the angle-of-view control processing. The camera 101 may implement each functional unit illustrated in FIG. 3 by hardware.

The CPU 201 may continue the angle-of-view control processing from steps S601 to S608 illustrated in FIG. 6 during image capturing. The CPU 201 may synchronize the start and end of angle-of-view control processing with the start and stop of the camera 101 or with an instruction to enable template imaging and automatic imaging received from the operation input apparatus 103. As pre-processing before executing the angle-of-view control processing, the CPU 201 may set a zoom value towards the wide-angle side or control pan or tilt to detect in advance an object present within a range that can be captured. The CPU 201 can efficiently search for a template by limiting in advance templates to be searched through by detecting an object in advance and may hold in advance candidates for the angle of view to which the templates can be applied.

In step S601, the control instruction reception unit 306 confirms whether a manual PTZ control signal has been received from the operation input apparatus 103. If the control instruction reception unit 306 has received a PTZ control signal, the imaging mode switching unit 307 is notified.

In step S602, the imaging mode switching unit 307 determines whether a manual control instruction has been received. If it is determined that a manual control instruction has been received from the control instruction reception unit 306, the imaging mode switching unit 307 proceeds to step S6090. If it is determined that a manual control instruction has not been received from the control instruction reception unit 306, the imaging mode switching unit 307 proceeds to step S603.

In step S6090, the imaging mode switching unit 307 switches the imaging mode to the manual imaging mode and proceeds to step S609.

In step S603, the image obtaining unit 301 obtains an image captured by the camera 101.

In step S604, the object detection unit 302 analyzes the image obtained by the image obtaining unit 301 in step S603 and detects an object in the image. The object detection unit 302 detects and outputs at least one of the category of the detected object, the direction of the object in the image, the position of the object in the image, and the size of the object in the image as information related to the object.

In step S605, the template search unit 305 searches for a template applicable to the angle of view of a currently captured image. Specifically, the template search unit 305 searches for one or more applicable templates from the template information table held by the template holding unit 304 based on the information related to the object detected by the object detection unit 302 in step S604. If a plurality of templates are obtained by the search, the template search unit 305 selects and outputs a template with the highest template priority as a template to be used for controlling the angle of view.

In step S606, if a template applicable to the currently captured angle of view has been found, the template search unit 305 outputs that a template has been found to the imaging mode switching unit 307 and proceeds to step S6070. If an applicable template could not be found, the template search unit 305 proceeds to step S6110.

In step S6070, the imaging mode switching unit 307 switches the imaging mode to the template imaging mode and proceeds to step S607.

In step S607, the object motion estimation unit 303 estimates whether a moving object whose category is specified in the template among objects detected in step S604 is traveling. If it is estimated that a moving object specified by the template is traveling, the object motion estimation unit 303 notifies the imaging mode switching unit 307 that the object is traveling. However, if it is determined that an object does not fall outside the direction range, position range, or size range specified by the template based the traveling speed, traveling direction, or the like of the object, the object motion estimation unit 303 does not need to make a notification that the object is traveling. Further, if an object not specified in the template is traveling, the object motion estimation unit 303 does not need to make a notification that the object is traveling. With this, if an object not related to reproduction of composition is traveling, the object motion estimation unit 303 can prevent the imaging mode from being unintentionally switched.

In step S608, if a notification that the object is traveling has been received from the object motion estimation unit 303, the imaging mode switching unit 307 proceeds to step S6110. If a notification has not been received from the object motion estimation unit 303, the imaging mode switching unit 307 proceeds to step S610.

In step S609, the control instruction reception unit 306 calculates and generates a PTZ parameter defining a speed, a distance, and a direction based on the control signal received from the operation input apparatus 103 and outputs the PTZ parameter to the angle-of-view change unit 310.

In step S610, the template reproduction control unit 308 calculates and generates a PTZ parameter so as to achieve the composition specified in the template outputted by the template search unit 305 and outputs the PTZ parameter to the angle-of-view change unit 310.

In step S6110, the imaging mode switching unit 307 switches the imaging mode to the automatic imaging mode.

In step S611, the automatic imaging control unit 309 calculates and generates a PTZ parameter defining a direction and speed for automatically tracking a traveling object based on an analysis result and outputs the PTZ parameter to the angle-of-view change unit 310. For example, the automatic imaging control unit 309 may generate a PTZ parameter based on, for example, the category, direction, position, and size of an object detected by the object detection unit 302 and at least one of the traveling speed and traveling direction of the object estimated by the object motion estimation unit 303. The automatic imaging control unit 309 may set a moving object to be tracked based on information specified by the operator through the operation input apparatus 103.

In step S612, the angle-of-view change unit 310 performs angle-of-view control according to the imaging mode determined by the imaging mode switching unit 307 in steps S6090, S6070, or S6110. At that time, the angle-of-view change unit 310 executes PTZ control for the camera 101 according to a PTZ parameter generated by one of the control instruction reception unit 306, the template reproduction control unit 308, and the automatic imaging control unit 309.

### Effects of Embodiment

As described above, the camera 101 according to the embodiment searches for a template applicable to control of the angle of view by PTZ control and executes PTZ control. With this, the present embodiment can reduce the burden required from the operator to search for a template and automatically control the angle of view based on a found template.

The present embodiment automatically controls the angle of view by determining the composition according to a template and, even if a template does not work, by continuing automatic imaging, can perform image capturing in which the burden of the operator is reduced.

The present embodiment can be applied to uses, such as live distribution (e.g., online events for which demand has increased in recent years) and video production (e.g., capturing videos for entertainment, such as music events, plays, sports viewing, etc.). Even when applied to such uses, the present embodiment can achieve the above effects.

The present embodiment detects information related to an object included in the image that includes any of the category, direction, position, and size of the object, and searches for an applicable template based on the information related to the object. With this, the present embodiment can search for a template that can be applied with high accuracy.

The present embodiment is configured to be capable of switching among the template imaging mode, the automatic imaging mode, and the manual imaging mode. With this, even when an applicable template cannot be found, the present embodiment can track and capture an image of an object in another imaging mode.

In the present embodiment, when a template is found, the template imaging mode is automatically set, and thus, the burden on the operator in setting the imaging mode can be further reduced.

In the present embodiment, even when a template is found, if a manual control instruction is received from the operator, the manual imaging mode is switched to, and thus, imaging according to what the operator desires can be realized.

In the present embodiment, when the template imaging mode or the manual imaging mode cannot be set, and the automatic imaging mode is automatically set, and thus, the burden on the operator in setting the imaging mode can be further reduced. Further, when there is no applicable template, the present embodiment sets the automatic imaging mode, and thus, even when there is no template applicable to control of the angle of view by PTZ control, it is possible to automatically continue imaging and automatically track an object.

The present embodiment searches for a template such that the category of an object in the template and the category of an object included in the image match, and thus, the angle of view can be controlled according to a template suitable for the object in the image.

The present embodiment searches for a template in which the direction, position, and size of an object in the image fall within at least one range among the direction range, position range, and size range of an object in the template. Thus, the present embodiment can control the angle of view according to a template that allows more reliable tracking of an object in the image.

In the present embodiment, since a template includes a template priority, an appropriate template can be found even when there are a plurality of templates applicable to control of the angle of view.

In the present embodiment, since a template includes an object priority, even when there are a plurality of objects in the image, a template suitable for an object according to what the operator desires can be found.

In the present embodiment, when it is determined that a plurality of templates can be applied as a result of a search for a template, a template with the smallest difference between the composition of the image and the composition changed according to the template is applied to the control of the angle of view. With this, the present embodiment can reduce the change in the angle of view by control according to a template.

The present disclosure can reduce burden on the operator and allows automatic control of the angle of view.

### OTHER EMBODIMENTS

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to exemplary embodiments, it is to be understood that the present disclosure is not limited to the disclosed exemplary embodiments. The scope of the following claims is to be accorded the broadest interpretation so as to encompass all such modifications and equivalent structures and functions.

This application claims the benefit of Japanese Patent Application No. 2024-103281, filed Jun. 26, 2024, which is hereby incorporated by reference herein in its entirety.

What is claimed is:

1. A control apparatus comprising:
one or more memories storing instructions; and
one or more processors executing the instructions to:
determine a template applicable to control of an angle of view of an imaging apparatus from a plurality of templates, each including predetermined information related to an arrangement of an object; and
control the angle of view of the imaging apparatus based on the arrangement of the object specified in the determined template.

2. The control apparatus according to claim 1, wherein
the template includes information related to at least one of a category of the object, a direction of the object, a position of the object, and a size of the object.

3. The control apparatus according to claim 1, wherein the one or more processors further execute the instructions to:
obtain an image captured by the imaging apparatus; and
detect at least one of a category of an object included in the captured image, a direction of the object, a position of the object, and a size of the object as information related to the object,
wherein the template applicable to control of the angle of view is determined based on the information related to the object.

4. The control apparatus according to claim 1, wherein the one or more processors further execute the instructions to set an imaging mode to one of a first imaging mode in which the angle of view is controlled based on the template, a second imaging mode in which the angle of view is manually controlled by an operator, and a third imaging mode in which the angle of view is automatically controlled based on a result of analysis of an image captured by the imaging apparatus,
wherein the angle of view is controlled based on the imaging mode.

5. The control apparatus according to claim 4, wherein
the imaging mode is set to the first imaging mode according to determination of the template.

6. The control apparatus according to claim 4, wherein
in a case where a control signal for controlling the angle of view has been received, the imaging mode is set to the second imaging mode regardless of the determination of the template.

7. The control apparatus according to claim 4, wherein
in a case where neither the first imaging mode nor the second imaging mode can be set, the imaging mode is set to the third imaging mode.

8. The control apparatus according to claim 3, wherein
the template includes information on at least one of a category of the object, a direction range of the object, a position range of the object, and a size range of the object as template information, and
in a case where the template includes information of category of the object as template information, a template which includes the category of the object included in the template information that matches the category of the object included in the information related to the object is determined.

9. The control apparatus according to claim 8, wherein
a template in which at least one of a direction of the object, a position of the object, and a size of the object included in the information related to the object falls within at least one range among the direction range, of the object, the position range of the object, and the size range of the object included in the template information is determined.

10. The control apparatus according to claim 8, wherein
the template includes a template priority indicating a priority of the template, and
in a case where a plurality of templates are applicable, one template from the plurality of applicable templates is determined based on the template priority.

11. The control apparatus according to claim 8, wherein
the template includes an object priority indicating a priority of the object, and
in a case where categories of a plurality of objects are included in information related to objects, the template is determined based on an object for which the object priority is high.

12. The control apparatus according to claim 8, wherein
in a case where a plurality of templates are applicable, the template for which a difference between composition of the image captured and composition of an angle of view changed according to the template is the smallest is determined.

13. The control apparatus according to claim 4, wherein
in a case where the template is determined and the object is not traveling, the imaging mode is set to the first imaging mode.

14. The control apparatus according to claim 4, wherein
in a case where the template is determined and the object is traveling within a range of the arrangement of the object indicated by the template, the imaging mode is set to the first imaging mode.

15. A control method comprising:
determining a template applicable to control of an angle of view of an imaging apparatus from a plurality of templates, each including predetermined information related to an arrangement of an object; and
controlling the angle of view of the imaging apparatus based on the arrangement of the object specified in the determined template.

16. A non-transitory computer-readable storage medium storing a computer program that, when read and executed by a computer, causes the computer to execute to a control method comprising
determining a template applicable to control of an angle of view of an imaging apparatus from a plurality of templates, each including predetermined information related to an arrangement of an object; and
controlling the angle of view of the imaging apparatus based on the arrangement of the object specified in the determined template.
